(19) United States
(12) Patent Application Publication
(10) Pub. No.: US 2025/0220637 A1
(43) Pub. Date: Jul. 3, 2025

(54) METHOD AND APPARATUS FOR PAGING

(71) Applicant: Nokia Technologies Oy, Espoo (FI)

(72) Inventors: Halit Murat GÜRSU, Munich (DE); Philippe GODIN, Massy (FR); Ugur Baran ELMALI, Munich (DE); Ömer BULAKCI, Munich (DE); Muhammad NASEER-UL-ISLAM, Munich (DE); Ahmad AWADA, Munich (DE); György Tamás WOLFNER, Budapest (HU)

(21) Appl. No.: 18/849,304

(22) PCT Filed: Mar. 28, 2022
(86) PCT No.: PCT/EP2022/058048

§ 371 Date: Sep. 20, 2024

(51) Int. Cl. H04W 68/02; H04W 48/18; H04W 72/0453; H04W 72/563

(52) U.S. Cl. CPC H04W 68/02; H04W 48/18; H04W 72/0453; H04W 72/563

(57) ABSTRACT

Techniques for paging with non-homogenous network slice support in area network are provided. For example, a method of paging of a user device is disclosed. The method comprises: receiving, by the user device, a paging message from a network node, the paging message comprising an index which indicates the paging message to correspond to a network slice or a cell; and receiving, by the user device, data from the network slice or the cell.

### TECHNICAL FIELD

The subject disclosure generally relates to wireless communication systems and more particularly, to wireless communication systems allowing to page a user device in a network. Yet more particularly, the subject disclosure provides methods and apparatuses of paging for slice.

### BACKGROUND

Wireless telecommunication systems are under constant development. There is a constant need for higher data rates and high quality of service. Reliability requirements are constantly rising and ways and means to ensure reliable connections and data traffic while keeping transmission delays minimal are constantly under development.

Developing networks enable new services to customers. One service is network slicing, which enables offering connectivity, quality of service and data processing solutions tailored to specific customers' requirements. A network slice is a logical end-to-end virtual network that can be dynamically created and that provides specific capabilities and characteristics. Multiple network slices may be created on top of a common shared physical network infrastructure to run services that may have different requirements on latency, reliability, throughput and mobility.

For example, in 5G, network slicing will be a key feature to support different services using the same underlying mobile network infrastructure. Network slices may differ either in their service requirements like Ultra-Reliable Low Latency Communication (URLLC) and enhanced Mobile Broadband (eMBB) or the tenant that provides those services.

The use of network slices may require techniques for enhanced paging behavior. So, there is a need for paging, specifically in case of non-homogenous slice support in a TA (tracking area) or in a RA (Registration Area).

### SUMMARY

According to a first aspect of the subject disclosure, a method of paging of a user device is provided. The method according to the first aspect may be performed by the user device. The method comprises: receiving, by the user device, a paging message from a network node, the paging message comprising an index which indicates the paging message to correspond to a network slice or a cell; and receiving, by the user device, data from the network slice or the cell.

The method at the user device may be used to allow paging the user device in registration area. In particular, the method may be used to provide paging in a non-homogenous network slice scenario.

In some embodiments of the first aspect, the method may comprise obtaining, by the user device, a frequency or frequency priority based on the index. In such embodiments, the method may further comprise performing, by the user device, re-selection to the network slice or the cell using the frequency or frequency priority.

In some embodiments of the first aspect, the method may further comprise receiving, by the user device, a configuration from the network node. The configuration comprises a mapping between a plurality of frequencies or frequency priorities and a plurality of indexes. In such embodiments, the mapping may be obtained from system information or dedicate signaling.

In some embodiments of the first aspect, the method may further comprise obtaining, by the user device, a frequency or frequency priority corresponding to the index from the mapping.

In some embodiments of the first aspect, the method may further comprise performing, by the user device, re-selection to the network slice or the cell using the obtained frequency or frequency priority.

In some embodiments of the first aspect, the method may further comprise setting up, by the user device, a connection in the network slice or to the cell; and/or sending, by the user device, a service request on the network slice or the cell.

In some embodiments of the method according to the first aspect, the user device may be camping on a first cell and the cell may be a second cell different to the first cell. The first cell and the second cell have overlapped coverage.

According to a second aspect of the subject disclosure, a method of paging of a user device is provided. The method according to the second aspect may be performed by one or more network nodes. The method comprises: sending, by a network node, a paging message to the user device, the paging message comprising an index which indicates the paging message to correspond to a network slice or a cell; and sending, to the user device, data from the network slice or the cell.

The method at the one or more network nodes may be used to allow paging the user device in registration area. In particular, the method may be used to provide paging in a non-homogenous network slice scenario.

In some embodiments of the second aspect, the method may comprise sending, by the network node, a configuration to the user device, the configuration comprising a mapping between a plurality of frequencies or frequency priorities and a plurality of indexes. In such embodiments, the method may further comprise providing, by the network node, the mapping by system information or dedicate signaling.

In some embodiments of the second aspect, the method may further comprise: deciding, by the network node, whether to set frequencies priorities (or perform redirection) based on a determination that the paging message corresponds to the network slice or the cell not supported by the network node.

In some embodiments of the second aspect, the method may further comprise setting up, by the network node, a connection in the network slice or the cell with the user device; and/or receiving a service request on the network slice or the cell.

In some embodiments of the method according to the second aspect, the user device may be camping on a first cell and the cell may be a second cell different to the first cell. The first cell and the second cell have overlapped coverage.

According to a third aspect of the subject disclosure, a user device is provided. The user device may comprise at least one processor; and at least one memory including computer program code. The computer program code causes the user device, when executed with the at least one processor, to at least: receive a paging message from a network node, the paging message comprising an index which indicates the paging message to correspond to a network slice or a cell; and receive data from the network slice or the cell.

The user device may be used to allow paging in registration area. In particular, the user device may be used to allow paging in a non-homogenous network slice scenario.

In some embodiments of the third aspect, the computer program code may cause the user device, when executed with the at least one processor, to: obtain a frequency or frequency priority based on the index. In such embodiments, the computer program code may further cause the user device, when executed with the at least one processor, to: perform re-selection to the network slice or the cell using the frequency or frequency priority.

In some embodiments of the third aspect, the computer program code may further cause the user device, when executed with the at least one processor, to: receive a configuration from the network node, the configuration comprising a mapping between a plurality of frequencies or frequency priorities and a plurality of indexes. In such embodiments, the mapping may be obtained from system information or dedicate signaling.

In some embodiments of the third aspect, the computer program code may further cause the user device, when executed with the at least one processor, to: obtain a frequency or frequency priority corresponding to the index from the mapping.

In some embodiments of the third aspect, the computer program code may further cause the user device, when executed with the at least one processor, to: perform re-selection to the network slice or the cell using the obtained frequency or frequency priority.

In some embodiments of the third aspect, the computer program code may further cause the user device, when executed with the at least one processor, to: set up a connection in the network slice or to the cell; and/or send a service request on the network slice or the cell.

In some embodiments of the user device according to the third aspect, the user device may be camping on a first cell and the cell may be a second cell different to the first cell.

According to a fourth aspect of the subject disclosure, a network device in a network is provided. The network device comprises at least one processor; and at least one memory including computer program code. The computer program code causes the network device, when executed with the at least one processor, to: send a paging message to a user device, the paging message comprising an index which indicates the paging message to correspond to a network slice or a cell; and send, to the user device, data from the network slice or the cell.

The network device may be used to allow paging the user device in a registration area or tracking area. In particular, the network device may be used to provide paging in a non-homogenous network slice scenario.

In some embodiments of the fourth aspect, the computer program code may cause the network device, when executed with the at least one processor, to: send a configuration to the user device, the configuration comprising a mapping between a plurality of frequencies or frequency priorities and a plurality of indexes. In such embodiments, the computer program code may further cause the network device, when executed with the at least one processor, to: provide the mapping by system information or dedicate signaling.

In some embodiments of the fourth aspect, the computer program code may further cause the network device, when executed with the at least one processor, to: decide whether to set frequency priorities (or perform redirection) based on a determination that the paging message corresponds to the network slice or the cell not supported by the network node.

In some embodiments of the fourth aspect, the computer program code further causes the network device, when executed with the at least one processor, to: set up a connection in the network slice or the cell with the user device; and/or receive a service request on the network slice or the cell.

In some embodiments of the network device according to the fourth aspect, the user device may be camping on a first cell and the cell may be a second cell different to the first cell. The first cell and the second cell have overlapped coverage.

According to a fifth aspect of the subject disclosure, a user device for paging in a network is provided. The user device comprises means of receiving a paging message from a network node, the paging message comprising an index which indicates the paging message to correspond to a network slice or a cell; and means of receiving data from the network slice or the cell. In an example, the user device according to the fifth aspect may however also be configured to comprise a first receiver to receive a paging message from a network node, the paging message comprising an index which indicates the paging message to correspond to a network slice or a cell; and a second receiver to receive data from the network slice or the cell.

According to a sixth aspect of the subject disclosure, a network device for paging in a network is provided. The network device comprises means of sending a paging message to a user device, the paging message comprising an index which indicates the paging message to correspond to a network slice or a cell; and means of sending, to the user device, data from the network slice or the cell. In an example, the network device according to the sixth aspect may however also be configured to comprise a first sender to send a paging message to a user device, the paging message comprising an index which indicates the paging message to correspond to a network slice or a cell; and a second sender to send, to the user device, data from the network slice or the cell.

According to a sixth aspect of the subject disclosure, a computer program product comprises program instructions stored on a computer readable medium to execute steps according to any one of the embodiments of the methods outlined above when said program is executed on a computer.

According to a seventh aspect of the subject disclosure, a non-transitory computer-readable medium containing computer-executable instructions which when run on one or more processors perform the steps according to any one of the embodiments of the methods outlined above.

The above-noted aspects and features may be implemented in systems, apparatuses, methods, articles and/or non-transitory computer-readable media depending on the desired configuration. The subject disclosure may be implemented in and/or used with a number of different types of devices, including but not limited to cellular phones, tablet computers, wearable computing devices, portable media players, and any of various other computing devices.

This summary is intended to provide a brief overview of some of the aspects and features according to the subject disclosure. Accordingly, it will be appreciated that the above-described features are merely examples and should not be construed to narrow the scope of the subject disclosure in any way. Other features, aspects, and advantages of the subject disclosure will become apparent from the following detailed description, drawings and claims.

### LIST OF ABBREVIATIONS

In the subject disclosure, the following abbreviations are used and should be understood in accordance with the given definitions:
3GPP 3^{rd} Generation Partnership Project
5G 5^{th} Generation (Mobile Communication Network)
5GC 5G Core
5GS 5G System
AF Application Function
AMF Access and Mobility Function
AN Access Network
APN Access Point Name
BS Base Station
CDMA Code Division Multiple Access
CN Core Network
CP Control Plane
DNN Data Network Name
eNB Evolved NodeB
EPC Evolved Packet Core
EPS Evolved Packet System
ETSI European Telecommunications Standards Institute
E-UTRAN Evolved UMTS Terrestrial Radio Access
IE Information Element
IMS IP Multimedia Subsystem
IP Internet Protocol
LTE Long Term Evolution
MME Mobility Management Entity
NAS Non-Access Stratum
NR New Radio
NSSAI Network Slice Selection Assistance Information
PDN Packet Data Network
PDP Packet Data Protocol
PGW PDN Gateway
PGW-C PGW Control Function
PLMN Public Land Mobile Network
RAN Radio Access Network
RCS Rich Communication Services
RRC Radio Resource Control (Protocol)
SGW Serving Gateway
SIM Subscriber Identity Module
SMF Session Management Function
S-NSSAI Single NSSAI
TS Technical Specification
UE User Equipment
URLLC Ultra-Reliable Low Latency Communication
VoNR Voice over NR

### BRIEF DESCRIPTION OF THE DRAWINGS

A better understanding of the subject disclosure can be obtained when the following detailed description of various embodiments is considered in conjunction with the following drawings, in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIG. 4 illustrates a network slicing scenario;

FIG. 5 illustrates an example scenario implementing concepts related to network slicing, tracking areas and registration area;

FIG. 6 illustrates a message sequence diagram for paging through the slice supporting cell;

FIG. 7 illustrates a message sequence diagram for paging a user device over a non-slice supporting cell;

FIGS. 8 and 9 illustrate flow charts of methods for paging a user device in a network according to some embodiments; and

FIG. 10 illustrates a message sequence diagram of a method for paging a user device in a network according to some embodiments.

### DETAILED DESCRIPTION

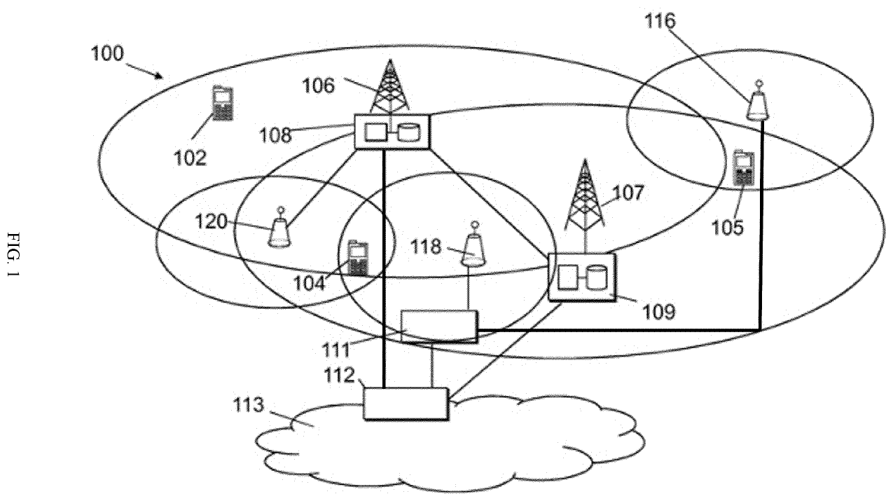

Before explaining the examples in detail, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices, user devices, user equipment (UE) 102, 104, 105 are provided wireless access via at least one base station (e.g., next generation NB, gNB), similar wireless transmitting and/or receiving node or network node. Base stations may be controlled or assisted by at least one appropriate controller apparatus, so as to enable operation thereof and management of mobile communication devices in communication with the base stations. The controller apparatus may be located in a radio access network (e.g., wireless communication system 100) or in a core network (CN) (not shown) and may be implemented as one central apparatus or its functionality may be distributed over several apparatuses. The controller apparatus may be part of the base station and/or provided by a separate entity such as a Radio Network Controller (RNC). In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

In FIG. 1, base stations 106 and 107 are shown as connected to a wider communications network 113 via gateway 112. A further gateway function may be provided to connect to another network.

As used herein, the term “base station” has the full breadth of its ordinary meaning, and at least includes a wireless communication station installed at a fixed location and used to communicate as part of a wireless telephone system or radio system. The communication area (or coverage area) of the base stations may be referred to as a “cell.” The base stations and the UEs may be configured to communicate over the transmission medium using any of various radio access technologies (RATs), also referred to as wireless communication technologies, or telecommunication standards described hereinbelow. As illustrated in FIG. 1, while one of the base stations may act as a “serving cell” for UEs, each UE may also be capable of receiving signals from (and possibly within communication range of) one or more other cells (which might be provided by the base stations and/or any other base stations), which may be referred to as “neighboring cells”.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example, wireless local area network (WLAN) and may be WLAN access points (Aps). The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long-term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (LTE-A) employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as WLAN and/or Worldwide Interoperability for Microwave Access (WiMax). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-A. Base stations of NR systems may be known as next generation Node Bs (gNBs). Changes to the network architecture may depend on the need to support various radio technologies and finer Quality of Service (QoS) support, and some on-demand requirements for e.g. QoS levels to support Quality of Experience (QoE) of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

An example 5G core network (CN) comprises functional entities. The CN is connected to a UE via the radio access network (RAN). An UPF (User Plane Function) whose role is called PSA (PDU Session Anchor) may be responsible for forwarding frames back and forth between the DN (data network) and the tunnels established over the 5G towards the UEs exchanging traffic with the data network (DN).

The UPF is controlled by an SMF (Session Management Function) that receives policies from a PCF (Policy Control Function). The CN may also include an AMF (Access & Mobility Function).

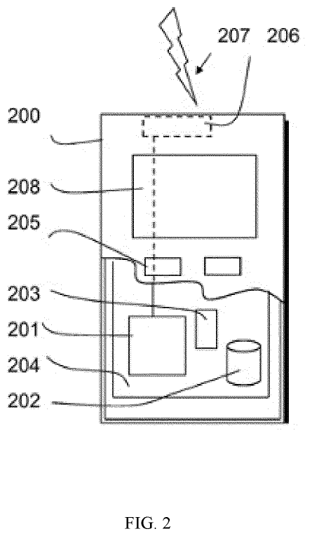

A possible (mobile) communication device 200 will now be described in more detail with reference to FIG. 2 showing a schematic, partially sectioned view. Such a mobile communication device 200 is often referred to as user equipment (UE), user device or terminal device. An appropriate mobile communication device 200 may be provided by any device capable of sending and receiving radio signals. Non-limiting examples comprise a mobile station (MS) or mobile device such as a mobile phone or what is known as a smart phone, a computer provided with a wireless interface card or other wireless interface facility (e.g., USB dongle), personal data assistant (PDA) or a tablet provided with wireless communication capabilities, or any combinations of these or the like. The communication device 200 may provide, for example, communication of data for carrying communications such as voice, electronic mail (e-mail), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

In an industrial application a communication device may be a modem integrated into an industrial actuator (e.g., a robot arm) and/or a modem acting as an Ethernet-hub that will act as a connection point for one or several connected Ethernet devices (which connection may be wired or unwired).

The communication device 200 is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets 204. The user may control the operation of the communication device 200 by means of a suitable user interface such as keypad 205, voice commands, touch sensitive screen or pad, combinations thereof or the like. A display 208, a speaker and a microphone can be also provided. Furthermore, the communication device 200 may comprise appropriate connectors (either wired or wireless) to other devices and/or for connecting external accessories, for example hands-free equipment, thereto.

The communication device 200 may receive signals over an air or radio interface 207 via appropriate apparatus for receiving and may transmit signals via appropriate apparatus for transmitting radio signals. In FIG. 2, transceiver apparatus is designated schematically by block 206. The transceiver apparatus 206 may be provided for example by means of a radio part and associated antenna arrangement. The antenna arrangement may be arranged internally or externally to the communication device 200.

The communication device 200 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Generally, the communication device 200 illustrated in FIG. 2 includes a set of components configured to perform core functions. For example, this set of components may be implemented as a system on chip (SoC), which may include portions for various purposes. Alternatively, this set of components may be implemented as separate components or groups of components for the various purposes. The set of components may be coupled (e.g., communicatively; directly or indirectly) to various other circuits of the communication device 200.

The communication device 200 may include at least one antenna in communication with a transmitter and a receiver (e.g., the transceiver apparatus 206). Alternatively, transmit and receive antennas may be separate. The communication device 200 may also include a processor (e.g., the at least one data processing entity 201) configured to provide signals to and receive signals from the transmitter and receiver, respectively, and to control the functioning of the communication device 200. The processor may be configured to control the functioning of the transmitter and receiver by effecting control signaling via electrical leads to the transmitter and receiver. Likewise, the processor may be configured to control other elements of the communication device 200 by effecting control signaling via electrical leads connecting processor to the other elements, such as a display (e.g., display 208) or a memory (e.g., the at least one memory 202). The processor may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, in some examples, the processor may comprise a plurality of processors or processing cores.

The communication device 200 may be capable of operating with one or more air interface standards, communication protocols, modulation types, access types, and/or the like. Signals sent and received by the processor may include signaling information in accordance with an air interface standard of an applicable cellular system, and/or any number of different wireline or wireless networking techniques, comprising but not limited to Wi-Fi, WLAN techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the communication device 200 and/or a cellular modem therein may be capable of operating in accordance with various third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like), or 5G beyond. For example, the communication device 200 may be capable of operating in accordance with 4G wireless communication protocols, such as LTE Advanced, 5G, and/or the like as well as similar wireless communication protocols that may be subsequently developed.

It is understood that the processor may include circuitry for implementing audio/video and logic functions of the communication device 200. For example, the processor may comprise a digital signal processor device, a microprocessor device, an analog-to-digital converter, a digital-to-analog converter, and/or the like. Control and signal processing functions of the communication device 200 may be allocated between these devices according to their respective capabilities. The processor may additionally comprise an internal voice coder (VC), an internal data modem (DM), and/or the like. Further, the processor may include functionality to operate one or more software programs, which may be stored in memory. In general, the processor and stored software instructions may be configured to cause the communication device 200 to perform actions. For example, the processor may be capable of operating a connectivity program, such as a web browser. The connectivity program may allow the communication device 200 to transmit and receive web content, such as location-based content, according to a protocol, such as wireless application protocol (WAP), hypertext transfer protocol (HTTP), and/or the like.

The communication device 200 may also comprise a user interface including, for example, an earphone or speaker, a ringer, a microphone, a display, a user input interface, and/or the like, which may be operationally coupled to the processor. The display may, as noted above, include a touch sensitive display, where a user may touch and/or gesture to make selections, enter values, and/or the like. The processor may also include user interface circuitry configured to control at least some functions of one or more elements of the user interface, such as the speaker, the ringer, the microphone, the display, and/or the like. The processor and/or user interface circuitry comprising the processor may be configured to control one or more functions of one or more elements of the user interface through computer program instructions, for example, software and/or firmware, stored on a memory accessible to the processor, for example, volatile memory, non-volatile memory, and/or the like. The communication device 200 may include a battery for powering various circuits related to the mobile terminal, for example, a circuit to provide mechanical vibration as a detectable output. The user input interface may comprise devices allowing the communication device 200 to receive data, such as a keypad (e.g., keypad 206) and/or other input devices. The keypad can also be a virtual keyboard presented on display or an externally coupled keyboard.

The communication device 200 may also include one or more mechanisms for sharing and/or obtaining data. For example, the communication device 200 may include a short-range radio frequency (RF) transceiver and/or interrogator, so data may be shared with and/or obtained from electronic devices in accordance with RF techniques. The communication device 200 may include other short-range transceivers, such as an infrared (IR) transceiver, a Bluetooth™ (BT) transceiver operating using Bluetooth™ wireless technology, a wireless universal serial bus (USB) transceiver, a Bluetooth™ Low Energy transceiver, a ZigBee transceiver, an ANT transceiver, a cellular device-to-device transceiver, a wireless local area link transceiver, and/or any other short-range radio technology. The communication device 200 and more specifically, the short-range transceiver may be capable of transmitting data to and/or receiving data from electronic devices within the proximity of the apparatus, such as within 10 meters, for example. The communication device 200 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The communication device 200 may comprise memory, such as one or more Subscriber Identity Modules (SIM), one or more Universal Subscriber Identity Modules (USIM), one or more removable User Identity Modules (R-UIM), one or more eUICC, one or more UICC, and/or the like, which may store information elements related to a mobile subscriber. In addition, the communication device 200 may include other removable and/or fixed memory. The communication device 200 may include volatile memory and/or non-volatile memory. For example, the volatile memory may include Random Access Memory (RAM) including dynamic and/or static RAM, on-chip or off-chip cache memory, and/or the like. The non-volatile memory, which may be embedded and/or removable, may include, for example, read-only memory, flash memory, magnetic storage devices, for example, hard disks, floppy disk drives, magnetic tape, optical disc drives and/or media, non-volatile random-access memory (NVRAM), and/or the like. Like volatile memory, the non-volatile memory may include a cache area for temporary storage of data. At least part of the volatile and/or non-volatile memory may be embedded in the processor. The memories may store one or more software programs, instructions, pieces of information, data, and/or the like which may be used by the apparatus for performing operations disclosed herein.

The memories may comprise an identifier, such as an International Mobile Equipment Identification (IMEI) code, capable of uniquely identifying the communication device 200. The memories may comprise an identifier, such as an international mobile equipment identification (IMEI) code, capable of uniquely identifying the communication device 200. In the example embodiment, the processor may be configured using computer code stored at memory to cause the processor to perform operations disclosed herein.

Some of the embodiments disclosed herein may be implemented in software, hardware, application logic, or a combination of software, hardware, and application logic. The software, application logic, and/or hardware may reside on the memory, the processor, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 2, computer-readable medium may comprise a non-transitory computer-readable storage medium that may be any media that can contain or store the instructions for use by or in connection with an instruction execution system, apparatus, or device, such as a computer.

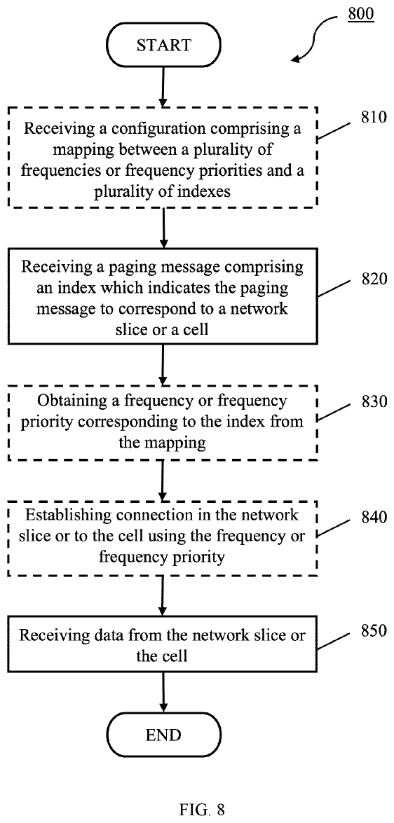

In some embodiments, the communication device 200 (i.e., a user equipment (UE) or a user device in a network) comprises the processor (e.g., the at least one data processing entity 201) and the memory (e.g., the at least one memory 202). The memory includes computer program code causing the communication device 200 to perform processing according to the methods described below with reference to FIG. 8.

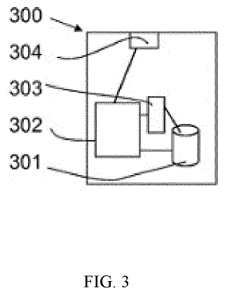

FIG. 3 shows an example embodiment of a control apparatus for a communication system, for example to be coupled to and/or for controlling a station of an access system, such as a RAN node, e.g., a base station, eNB or gNB, a relay node or a core network node such as an MME or S-GW or P-GW, or a core network function such as AMF/SMF, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

Generally, the control apparatus 300 has an antenna, which transmits and receives radio signals. A radio frequency (RF) transceiver module, coupled with the antenna, receives RF signals from antenna, converts them to baseband signals and sends them to processor (e.g., the at least one data processing unit 302, 303). RF transceiver also converts received baseband signals from processor, converts them to RF signals, and sends out to antenna. Processor processes the received baseband signals and invokes different functional modules to perform features in control apparatus 300. Memory (e.g., the at least one memory 301) stores program instructions and data to control the operations of the control apparatus 300. In the example of FIG. 3, the control apparatus 300 also includes protocol stack and a set of control functional modules and circuit. PDU session handling circuit handles PDU session establishment and modification procedures. Policy control module that configures policy rules for UEs. Configuration and control circuit provides different parameters to configure and control UEs of related functionalities including mobility management and session management. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines.

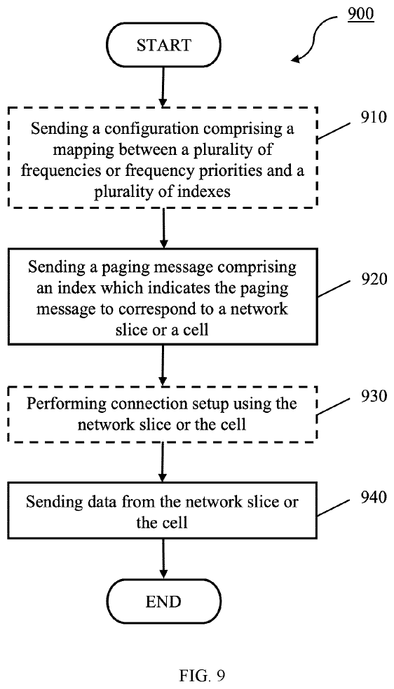

In some embodiments, the control apparatus 300 (i.e., a base station, a wireless transmitting and/or receiving point equipment, or a network node in a network) comprises the processor (e.g., the at least one data processing unit 302, 303) and the memory (e.g., the at least one memory 301). The memory includes computer program code causing the control apparatus 300 to perform processing according to the method described below with reference to FIG. 9.

Before referring to FIG. 8 to FIG. 10 and describing the methods for paging a user device in a network according to some embodiments of the subject disclosure, some background information and aspects related to the subject disclosure will be provided.

As mentioned, network slicing is a concept where network resources of an end-to-end connection between a user device (i.e., a user equipment, UE) and another end point in a network such as a Public Land Mobile Network (PLMN) are sliced. Similar network slicing may be employed also in private networks. A network slice may be understood as a logical end-to-end network that can be dynamically created and/or modified. The network(s) between the end devices may all be sliced from one end device to the other end device, the slices thus forming logical pipelines within the network(s). User devices may access a slice over a radio interface. As described in 3GPP TS 38.300 (e.g., version 16.8.0 Release 16, 2022-01), network slicing will be a key feature in 5G to support different services using the same underlying mobile network infrastructure.

A pipeline/slice may serve a particular service type. So far, three different network slice/service types have been considered mainly: eMBB (slice suitable for the handling of 5G enhanced Mobile Broadband), URLLC (slice suitable for the handling of Ultra-Reliable Low Latency Communication) and MIoT (slice suitable for the handling of massive Internet of Things). Communications Service Providers (CSPs) are able to define additional network slice/service types if needed. A given user device may access to multiple slices over the same Access Network (over the same radio interface, for example).

Thus, network slicing enables a communications service provider to provide dedicated virtual networks over a common network infrastructure. The different virtual or logical networks may be designed to provide different networking characteristics such as different qualities of service (QoS) in order to host services with diverse requirements and service level agreements (SLAs). For example, the virtual networks may be customized to meet specific needs of various applications, services, devices, customers and/or operators. Thus, the network slicing enables provision of different services to the terminal device. In an example, network slices may differ either in their service requirements like URLLC and eMBB or the tenant that provides those services.

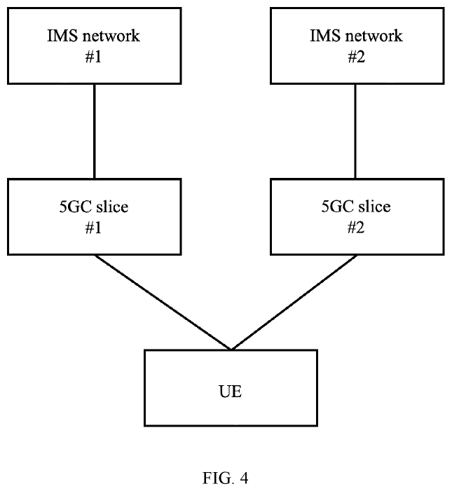

An illustration of a scenario in which a user device (i.e., the UE) uses two different services provided by two different networks (e.g., IMS networks) is provided by FIG. 4. In this scenario, the UE is connected through two different network slices (e.g., 5GC network slices) to the IMS networks. That is, the UE is connected through 5GC slice #1 to the IMS network #1 and uses a service provided by the IMS network #1 (e.g., RCS). The UE is also connected through 5GC slice #2 to the IMS network #2 and uses a service provided by the IMS network #2 (e.g., VoNG). This allows to customize the network slices for the different services hosted by each of the IMS networks.

A network slice is uniquely identified via the Single-Network Slice Selection Assistance Information (S-NSSAI). Current 3GPP specifications (e.g., 3GPP TS 38.300 version 16.8.0 Release 16, 2022-01) allow a user device to be simultaneously connected and served by at most eight network slices corresponding to eight S-NSSAIs. On other hand, each cell may support tens or even hundreds of S-NSSAIs. In current 3GPP specifications (e.g., 3GPP TS 38.423 version 16.8.0 Release 16, 2022-01), a tracking area (TA) can have a support up to 1024 network slices.

The format of the S-NSSAI may include both Slice Service Type (SST) and Slice Differentiator (SD) fields with a total length of 32 bits or include only SST field part in which case the length of S-NSSAI is 8 bits only. Examples of the format are described in 3GPP specifications such as 3GPP TS 23.501 or 3GPP TS 23.003. The SST field may have standardized and non-standardized values. Values 0 to 127 belong to the standardized SST range. For instance, SST value of 1 may indicate that the slice is suitable for handling of 5G eMBB, 2 for handling of URLLC, etc. SD is operator-defined only.

Other concepts concern defining a tracking area (TA) and a registration area (RA). The TA is a logical concept of an area where a user can move around without updating the MME and is the LTE, EPS or 5GS counterpart of the location area and routing area of GSM, WCDMA and GPRS. The TA consists of a set of cells. TAs can be grouped into lists of tracking areas (TA lists), which can be configured on the UE. For example, the network allocates a list with one or more TAs to the user. In certain operations, the UE may move freely in all TAs of the list without updating the MME. The RA is a list consisting of tracking areas (TAs), which is configured to the UE by the network. The RA are used to track the UE for paging purposes. If the UE leaves the RA, the UE will let the network know through NAS registration request (referred to as mobility registration update) such that the correct RA can be configured to the UE.

In 5G, the RA also has the role to maintain allowed slices (alternatively allowed NSSAI) of the UE. The allowed NSSAI is configured to the UE by the network. Throughout the subject disclosure, an allowed S-NSSAI can refer to an S-NSSAI included in the allowed NSSAI. The UE NAS can request access to an S-NSSAI and the network would decide to add that S-NSSAI to the UE's list or not.

In recent developments, agreement to have homogenous slice support within a TA, as well as RA, was achieved. This means that the same slices are to be supported throughout a TA, and the allowed NSSAI is valid throughout the RA of the UE.

However, in may be expected that in further developments, the RA may comprise multiple TAs that are not supporting all allowed slices of the UE, allowing a more flexible registration area configuration. However, such developments may have a fundamental trade-off with the paging mechanism.

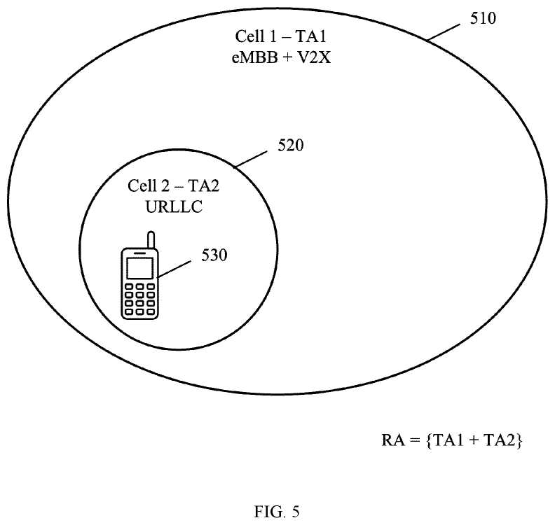

FIG. 5 illustrates an example scenario implementing the concepts related to network slicing, tracking areas and registration area.

In the example scenario, the user device (e.g., UE) 530 is configured with a registration area (RA) that comprises two tracking areas such as a first tracking area (TA1) 510 and a second tracking area (TA2) 520. That is, RA is defined as RA={TA1+TA2}. In FIG. 5, the first tracking area (TA1) corresponds to a first cell (cell 1) and the second tracking area (TA2) corresponds to a second cell (cell 2).

In the first tracking area (TA1) or the first cell (cell 1), two network slices are configured. One of these two network slices provides a first service such as eMBB while the other provides a second service such as V2X. In the second tracking area (TA2) or the second cell (cell 2), a network slice providing a third service such as URLLC is configured.

The UE 530 has the slices providing the first (eMBB), second (V2X) and third (URLLC) service as allowed slices.

In the example scenario shown in FIG. 5, the UE 530 is assumed to be camping on the second cell (cell 2) in the second tracking area (TA2) and thus is enabled to use the third service (URLLC).

When the UE 530 is being paged for a PDU session of the second service (V2X), the network (e.g., AMF) sends a paging message to the first cell (cell 1) which supports the second service (V2X) and possibly to other cells of the first tracking area (TA1). The UE 530 is however not camping on the first cell (cell 1) and the paging message can therefore not be received by the UE 530. So, the network (e.g., AMF) may decide to nor (and even never) send paging messages to any cell under the second tracking area (TA2), as no cell of TA2 supports the second service (V2X). This may cause a paging problem in the example scenario illustrated in FIG. 5.

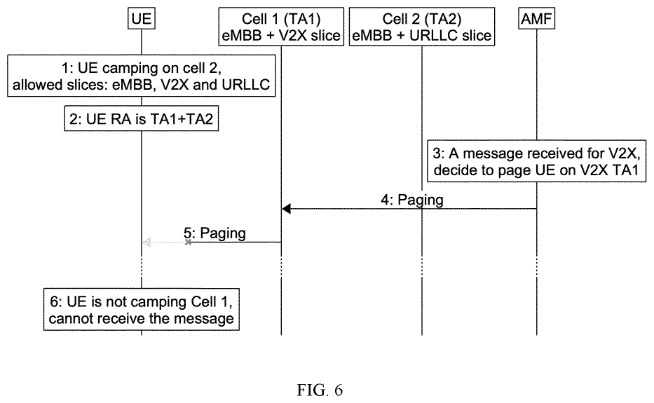

In FIG. 6, a message sequence diagram for paging through the slice supporting cell is illustrated. The message sequence diagram illustrates the message exchanged between, and operations performed by, user devices/network nodes of a network similar to the example scenario illustrated in FIG. 5.

The network of FIG. 6 may comprise one or more network nodes (e.g., one or more base stations and one or more control functions) and at least one user equipment (UE). The network comprises two cells, including a first cell (cell 1) and a second cell (cell 2). In the network, a first tracking area (TA1) comprising the first cell (cell 1) and a second tracking area (TA2) comprising the second cell (cell 2) is defined. The cells (or tracking areas) are each controlled or served by one of the base stations. For example, a first base station controls the first cell (cell 1) that is associated with the first tracking area (TA1), while a second base station controls the second cell (cell 2) that is associated with the second tracking area (TA2). The network further comprises a core network function such as AMF. In the network, network slices are configured. Two network slices configured in the first cell (cell 1) comprises eMBB and V2X slices (designated eMBB+V2X slice in FIG. 6) and two network slices configured in the second cell (cell 2) comprises eMBB and URLLC slices (designated eMBB+URLLC slice in FIG. 6). Thus, the base station serving the first cell (cell 1) provides the eMBB+V2X slice and eMBB and V2X services to UEs camping on the first cell (cell 1). On the other hand, the base station serving the second cell (cell 2) provides the eMBB+URLLC slice and eMBB and URLLC services to UEs camping on the second cell (cell 2).

As shown in step 1 of FIG. 6, the UE may be camping on the second cell (cell 2) and the UE has network slices providing the eMBB service, the V2X service and the URLLC service as allowed slices. Further, as shown in step 2 of FIG. 6, the registration area (RA) comprising the first and second tracking areas (TA1 and TA2) is configured to the UE.

At step 3, in the network, a message for a service may be received. For example, the core network function (e.g., the AMF) may receive a message for a service provided by the network (e.g., the V2X service). The network decides to page the UE to which the message is to be provided on the cell (i.e., the cell on which the UE is camping, which is cell 2) or on the first tracking area (TA1) with the V2X service/V2X slice. For example, the AMF may decide to page the UE for V2X mobile-terminating (MT) data (i.e., for data relating to the V2X service which is to be provided to and thus terminating at the UE).

In response to deciding at step 3, the network sends a paging message towards the UE at step 4. For example, the AMF sends the paging message to the base station serving the first cell (cell 1) or providing the first tracking area (TA1). The AMF sends the paging message to the base station serving cell 1 and TA1 as said base station serves the only cell (i.e., cell 1) supporting V2X and eMBB in the RA of the UE.

In response to receiving the paging message from the AMF, the base station serving the first cell (cell 1) and the first tracking area (TA1) sends a paging message towards the UE at step 5.

However, at step 6, as the UE is camping on the second cell (cell 2) but not on the first cell (cell 1), the UE cannot receive the paging message sent by the base station at step 5, causing the paging problem.

As a result, the UE does not receive the paging message informing the UE about the V2X MT data which the AMF received and which are to be provided by the AMF to the UE. Thus, since the UE is not informed about the V2X MT data, the UE will not perform a service request and will therefore not (i.e., never) receive the V2X MT data.

If radio coverages of the first and second cells (cell 1 and cell 2) are overlapping as illustrated in the example scenario of FIG. 1 (e.g., in case of different frequency bands), the behavior leading to the paging problem is suboptimal, as the UE is under coverage of the first cell (cell 1) as well. The UE cannot receive the paging message from the first cell (cell 1) as the UE does not monitor paging occasions from the first cell (cell 1) as the UE is camping on the second cell (cell 2). In the art, the UE is monitoring paging occasions only from the (single) cell that is camping in the same PLMN.

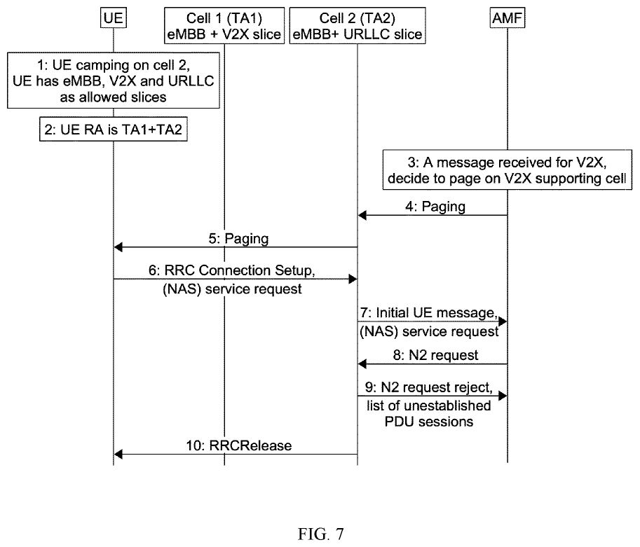

An approach for mitigating the paging problem will be described hereinbelow with reference to FIG. 7 illustrating a message sequence diagram for paging a user device over a non-slice supporting cell. According to the approach, the network (e.g., AMF) pages the whole registration area or tracking area (TA) which includes non-slice supporting cells. The approach will be described for a network that corresponds to the network used in conjunction with the description of FIG. 6.

In step 1 of FIG. 7, the UE may be camping on the second cell (cell 2) and the UE has network slices providing the eMBB service, the V2X service and the URLLC service as allowed slices. Further, as shown in step 2 of FIG. 8, the registration area (RA) and/or tracking area comprising the first and second tracking areas (TA1 and TA2) is configured to the UE.

At step 3, in the network, a message for a service may be received. For example, the core network function (e.g., the AMF) may receive a message for a service provided by the network (e.g., the V2X service). The network decides to page the UE to which the message is to be provided on the cell supporting the service (i.e., a cell supporting the V2X service). For example, the AMF may decide to page the UE for V2X mobile-terminating (MT) data (i.e., for data relating to the V2X service which is to be provided to and thus terminating at the UE) in a cell of the RA or TA configured to the UE (e.g., the first cell supporting the V2X service).

In response, the network sends a paging message towards the UE at step 4. For example, the AMF sends the paging message to the base station serving the second cell (cell 2) as the second cell (cell 2) is a cell in the RA or TA of the UE. The basis station serving the second cell (cell 2) sends the paging message to the UE at step 5.

The UE receiving the paging message from the base station and thus being informed about the data of the service (e.g., the V2X MT data of the V2X service) sends an RRC connection setup request and a service request (e.g., a NAS service request) to the base station serving the second cell (cell 2), at step 6. The RRC connection setup request and the service request are to establish a connection and request data for the service (i.e., the V2X service).

At step 7, the (NAS) service request is sent by the base station to the AMF. The base station may send an initial UE message at step 7. The AMF may respond to the base station by sending an N2 request to the cell (i.e., the second cell) at step 8. That is, the AMF sends the N2 request to the base station serving the second cell. As the base station does not support the service (i.e., the V2X service) requested by the UE, the base station rejects the request. For example, the base station rejects the service request by sending an N2 request reject message to the AMF at step 9. The base station may also send a list of unestablished PDU sessions to the AMF.

As the service request is rejected, the base station releases the US by sending an RRC release message to the UE at step 10, as no PDU session can be initiated.

Another approach for mitigating the paging problem involves paging with non-homogenous network support. According to this approach, the network is aware of the overlapping coverage of different cells so that the network may page the UE over the non-slice supporting cell to be re-directed to the slice supporting cell. However, this approach requires the UE to either go to the RRC connected mode or to initiate RRC connection setup to be guided to the cell which supports the service. This introduces processing load on network nodes such as the RAN node and delay in the service access of the UE.

Consequently, an approach is required which mitigates the paging problem and at the same time reduces processing load and avoids delay in the service access caused by requiring the UE to either go to the RRC connected mode or to initiate RRC connection setup. The subject disclosure provides a method for enhanced paging behavior with non-homogenous slice support in a tracking area (TA) or in a registration area (RA).

Now, the methods for paging a user device in a network according to some embodiments of the subject disclosure will be described.

According to a general example of the method for paging the user device (e.g., UE) in the network, the UE is configured with multiple frequencies and frequency priorities. The multiple frequencies and/or frequency priorities are mapped to an index. The paging message (e.g., the RRC paging message) is enhanced and includes an index to a frequency and/or frequency priority. The mapping is received by the UE in advance. Alternatively, frequency to be prioritized can be included in the paging message. Besides the UE is made aware prior to paging with the frequency-index mapping (or the mapping between frequency priority list and the indexes), typically by broadcast such mapping in the cell.

The UE refrains from initiating RRC connection setup and sending the service request in the cell on which the UE is camping immediately after receiving the paging message but instead reselects to the cell according to the frequency or frequency priority that corresponds to the index in the paging message and sends the service request to the AMF through the reselected cell. The UE is thus steered to send the service request to a cell which supports the slice related to the paging message.

FIG. 8 illustrates a flow chart of a method for paging a user device in a network according to some embodiments. The method is performed by a user device (also referred to as a user equipment (UE)), or an apparatus for use in a user device. For example, the UE may be represented by any one of the mobile communication devices 102, 104, 105 of the wireless communication system 100 as described above with reference to FIG. 1, or the communication device 200 as described above with reference to FIG. 2.

In an example, the network may comprise at least two cells, including a first cell and a second cell. Each cell corresponds to or belongs to a tracking area. For example, in the network, a first tracking area comprises the first cell and a second tracking area comprises the second cell. The first cell and the second cell (or tracking areas) are each controlled or served by a base station. A first base station controls the first cell and/or the first tracking area, while a second base station controls the second cell and/or the second tracking area. The network further comprises a core network function. In the network, the concept of network slicing is established. The network slices configured in the network may comprise a first slice configured in both cells (i.e., the first cell and the second cell) and providing a first service, a second slice configured in the first cell and providing a second service, and a third slice configured in the second cell and providing a third service.

The UE may be camping on one of the cells (e.g., the second cell) of the network and the first slice and the second slice may be configured as allowed slices for the UE. That is, the UE is allowed to use the services of the first slice and the second slice. The first and second tracking areas may be configured to the UE and a registration area comprising the first and second tracking areas may be configured to the UE by the network.

At block 820, the UE receives a paging message from the network. In the example, the UE may receive the paging message from the second base station of the second cell on which the UE is camping. The paging message comprises an index indicating that the UE will be paged from a different cell (e.g., from the first cell on which the UE is not camping) in a different (carrier) frequency (the different cell is not in the same frequency as the frequency of the cell on which the UE is camping). In order to allow the UE for being paged from the different cell, the UE needs to find the different cell through setting a frequency priority and measuring cells in a frequency. In other words, the index indicates that the paging message corresponds to a different cell (i.e., a cell different from the cell on which the UE is camping) or a different frequency (i.e., a frequency different from the frequency of the cell on which the UE is camping). The index may also indicate that the paging message relates to a different network slice (based on which the UE may derive that the paging message corresponds to a different cell or different frequency). That is, in the example, the paging message may comprise an indication that the paging message corresponds or relates to the second slice (e.g., the second service). In the example, the paging message may also comprise an indication that the paging message corresponds to the first cell. As will be described in more detail hereinbelow, the UE may be configured by the network with a mapping of frequencies or frequency priorities to indexes. For example, a plurality of frequencies or frequency priorities corresponding to the slices or the cells are each mapped to an index. So, the index included in the paging message may be used by the UE to obtain a frequency or frequency priority relating to the slice or the cell from the mapping.

The paging message may be sent by the network (e.g., a base station or a network node) in response to determining that data relating to a service is to be provided to the UE. For example, the core network function may need to page the UE for data relating to the second service. In case the second service is URLLC, the data may be URLLC Mobile-Terminating (MT) data. As mentioned, the UE may be camping on the second cell and the second slice providing the second service is configured at the UE as an allowed slice. However, the second slice providing the second service for which data is to be provided to the UE is not configured for the second cell on which the UE is camping. As the UE is camping on the second cell while the second slice or the second service is not configured for the second cell but instead for the first cell on which the UE is not camping, the data cannot be provided to the UE. Instead, the UE needs to establish connection to the first cell and request for the service (e.g., the second service) for which data is to be provided to the UE. In response to establishing connection to the first cell, the UE is enabled to receive the data from the network.

At page 850, the UE receives the data from the network slice or the cell. As described, the UE may receive an index indicating the network slice or the cell with the paging message. Using the index, the UE may be enabled to establish a connection in the network slice or to the cell to which the paging message corresponds. In response to establishing the connection in the network slice or to the cell, the UE may receive the data from the network slice or the cell. In the example, the UE may receive the URLLC MT data for the URLLC service from the network.

In some examples, the method 800 may further comprise, at block 810, receiving a configuration from the network. The configuration comprises a mapping between a plurality of frequencies or frequency priorities and a plurality of indexes. The UE may receive the configuration from a network node such as the second base station of the second cell on which the UE is camping. The plurality of frequencies or frequency priorities corresponding to network slices or cells are each mapped to an index. The index may be a unique index such that the frequency or the frequency priority can be uniquely obtained from the mapping using the index. The index included in the paging message may be used by the UE to obtain, using the mapping, a frequency or frequency priority relating to the network slice or the cell. The mapping may be prepared by the network (e.g., a network node such as the second base station). More specifically, the network may provide the mapping by system information or dedicate signaling. The mapping may comprise a list of frequency values or priorities specific for the network slice or the cell to which the paging message corresponds, i.e., the network slice or the cell for which the UE is paged by the network to provide data of a service.

In some other examples, the method 800 may further comprise, at block 830, obtaining a frequency or frequency priority based on the index. That is, in response to receiving the paging message from the network, the UE may use the index included in the paging message to obtain the frequency or frequency priority from the mapping.

In some examples, the method 800 may comprise, at block 840, establishing a connection in the network slice or to the cell indicated in the paging message. For example, the UE may perform a re-selection to the network slice or the cell using the frequency or frequency priority obtained at block 830. The UE may perform a connection setup in the network slice or to the cell using the frequency or frequency priority and performs a service request. For example, the UE may perform the connection setup with the first base station to establish connection to the first cell. The service request may be sent to the core network function of the network in response to which the network can sent the data (e.g., the URLLC MT data) for which the paging message was sent to the UE at block 820.

FIG. 9 illustrates a flow chart of a method for paging a user device in a network according to some embodiments. The method is performed by the network. More specifically, the method may be performed by one or more network nodes or network functions of the network, or an apparatus for use in a network node or by a network function. For example, the method may be performed by a base station such as the base station represented by the control apparatus 300 as described above with reference to FIG. 3, and/or a core network function such as AMF.

As already discussed above, in an example, the network may comprise at least two cells, including a first cell and a second cell, each corresponding to a respective tracking area. The cells (or tracking areas) are each controlled or served by a base station (i.e., a first base station and a second base station). In the network, the network slices such as the first slice, the second slice and the third slice are configured. The first slice may be configured in both cells (i.e., the first cell and the second cell) and providing a first service, the second slice configured in the first cell and providing a second service, and a third slice configured in the second cell and providing a third service.

The UE may be camping on one of the cells (e.g., the second cell) of the network and the first slice and the second slice may be configured as allowed slices for the UE. The first and second tracking areas may be configured to the UE and a registration area comprising the first and second tracking areas may be configured to the UE by the network.

At block 920, the network sends a paging message to the UE. For example, the paging message may be sent by a network node such as a base station serving the cell on which the UE is camping to the UE. In the example, the second base station serving the second cell on which the UE is camping may send the paging message to the UE. The paging message comprises an index indicating that the paging message corresponds to a network slice or a cell. In the example, the paging message may comprise an indication that the paging message corresponds to the second slice (e.g., the second service). In the example, the paging message may also comprise an indication that the paging message corresponds to the first cell.

At block 940, the network sends the data from the network slice or the cell to the UE. For example, the network node or the core network function may send the data to the UE. As described, an index indicating the network slice or the cell is sent to the UE with the paging message and the UE used the index to identify and established a connection in the network slice or to the cell with the UE. In response to establishing the connection in the network slice or to the cell and a service request to the network, the network sends the data from the network slice or the cell to the UE.

In some examples, the method 900 may further comprise, at block 910, sending a configuration from the network to the UE. The configuration comprises a mapping between a plurality of frequencies or frequency priorities and a plurality of indexes. The network node such as the base station serving the cell on which the UE is camping may send the configuration. The plurality of frequencies or frequency priorities corresponding to network slices or cells are each mapped to an index. The index may be a unique index such that the frequency or the frequency priority can be uniquely obtained from the mapping using the index. The index included in the paging message may be used by the UE to obtain, using the mapping, a frequency or frequency priority relating to the network slice or the cell. The mapping may be prepared by the network (e.g., the network node such as the base station). More specifically, the network may provide the mapping by system information or dedicate signaling. The mapping may comprise a list of frequency values or priorities specific for the network slice or the cell to which the paging message corresponds, i.e., the network slice or the cell for which the UE is paged by the network to provide data of a service.

In some other examples, the method 900 may further comprise, at block 930, performing a connection setup using the network slice or the cell indicated in the paging message with the UE. For example, using the frequency or frequency priority obtained by the UE from the mapping using the index, the UE may perform a connection setup in the network slice or to the cell and performs a service request. For example, the UE may perform the connection setup with a network node such as a base station supporting the network slice or the cell to establish the connection. The service request may be sent to the core network function of the network in response to which the network sends the data for which the paging message was sent to the UE at block 920.

In other examples, the network may decide whether to set or adjust frequency priorities (or perform redirection) of the paging message to be sent to the UE at block 920. The network such as the network node (e.g., the base station serving the cell on which the UE is camping) decides based on a determination that the paging message corresponds to a network slice or a cell not supported by the network node. That is, the network slice or the cell to which the paging message corresponds is not served by the network node (e.g., the base station) but by another network node (i.e., another base station) of the network. If so, the paging message needs to be redirected to the network slice or the cell to which the paging message corresponds and the network sends the paging message including the index. That is, the network node includes the index indicating the network slice or the cell in the paging message.

For example, network may need to provide the UE with data of the URLLC service (i.e., URLLC MT data) and therefore needs to page the UE. If the UE is camping on a cell which does not support the URLLC service, the UE is paged by providing an index indicating the network slice or the cell that supports the URLLC service into a mapping between network slices or cells and indexes. The UE uses the index to obtain information (e.g., frequency values or frequency priorities) needed to establish a connection in the network slice or to the cell. The data (e.g., URLLC MT data) may then be sent from the network slice or the cell to the UE.

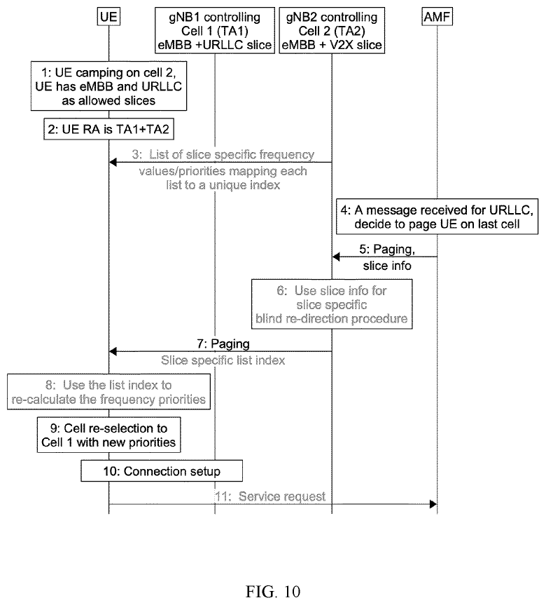

FIG. 10 illustrates an exemplary message sequence diagram of a method for paging a user device in a network according to some embodiments. The message sequence diagram illustrates the message exchanged between, and operations performed by, user devices/network nodes of the network. For example, the network (e.g., a 5G network) may comprise the example communication system as illustrated in FIG. 1. The network may comprise one or more network nodes (e.g., one or more base stations and one or more control functions; an exemplary network node or apparatus for use in a network node is illustrated in FIG. 3) and at least one communication device (e.g., a user device such as the user equipment (UE) as illustrated in FIG. 2 or an apparatus for use in a user device).

In the example of FIG. 10, the network comprises at least two cells, including a first cell (cell 1) and a second cell (cell 2). Each cell corresponds to a tracking area. In the network, a first tracking area (TA1) comprising the first cell (cell 1) and a second tracking area (TA2) comprising the second cell (cell 2) is defined. The cells (or tracking areas) are each controlled or served by one of the base stations. For example, a first base station (gNB1) controls the first cell (cell 1) and/or the first tracking area (TA1), while a second base station (gNB2) controls the second cell (cell 2) and/or the second tracking area (TA2). The network further comprises a core network function such as AMF.

In the network, network slices are configured. The network slices comprise a first slice configured in both cells (i.e., the first cell and the second cell) and providing a first service (e.g., eMBB), a second slice configured in the first cell and providing a second service (e.g., URLLC), and a third slice configured in the second cell and providing a third service (e.g., V2X). Thus, the first base station (gNB1) serving the first cell (cell 1) and/or the first tracking area (TA1) provides the first and second slices and thus the first and second services (i.e., eMBB and URLLC) to the UEs camping on the first cell (cell 1).

On the other hand, the second base station (gNB2) serving the second cell (cell 2) and/or the second tracking area (TA2) provides the first and third slices and thus the first and third services (i.e., eMBB and V2X) to Ues camping on the second cell (cell 2). Each of the network slices and/or cells use specific frequency values or frequency priorities (i.e., one or more).

As shown in step 1 of FIG. 10, it is assumed that the UE is camping on the second cell (cell 2) served by the second base station (gNB2) and thus enabled to be provided with first service (eMBB) in the first slice and the third service (V2X) in the third slice. In the example of FIG. 10, it is assumed that the UE is configured for the first service (eMBB) and the second service (URLLC). That is, the first and second services (or first and second slices) are allowed services (or allowed slices). The UE is however not configured for the third service (V2X) and thus the third slice (or third service) is not an allowed slice (or allowed service). That is, the UE is allowed to use the services of the first slice (eMBB) and the second slice (URLLC). Further, as shown in step 2 of FIG. 10, it is assumed that a registration area (RA) comprising the first and second tracking areas (TA1 and TA2) is configured to the UE by the network.

At step 3, the second base station (gNB2) serving the second cell (cell 2) on which the UE is camping configures a list of frequencies values or frequency priorities mapping at least one of the frequency values or frequency priorities to an index (e.g., a unique index). That is, as already described above, at the network and more specifically by a network node such as the second base station (gNB2), a mapping between a plurality of frequencies or frequency priorities and a plurality of indexes is configured. The frequencies (i.e., frequencies values) or the frequencies priorities are specific for network slices or cells configured in the network. The network slices or cells of which the frequencies or the frequencies priorities are mapped to indexes in the mapping are not limited to network slices and cells provided/served by the second base station (gNB2). Instead, the network slices or cells are configured in the network. The second base station (gNB2) sends the list of the frequency values or the frequency priorities (i.e., the mapping) as configuration to the UE.

The frequency values or the frequency priorities of the list are used by the UE for cell selection. For example, one or more of the frequency values may be used by the UE as frequencies to measure for cell re-selection to a cell (e.g., cell 1). Likewise, one or more of the frequency priorities may be used to set priorities among frequencies for slice specific cell re-selection.

The configuration the second base station (gNB2) configured for and sent to the UE may further comprise a default index to be used by the UE. That is, the mapping may comprise a mapping between a frequency or a frequency priority which the UE uses by default if no index is signaled to the UE. For example, the second base station (gNB2) may signal the frequency or frequency priority of a cell such as the second cell (cell 2) the second base station (gNB2) serves as default. That is, the index mapped to the frequency or frequency priority of that cell is indicated as the default index. The second base station (gNB2) may also indicate a network slice provided by the second base station (gNB2) as default by indicating the index mapped to the frequency or frequency priority of that network slice as the default index.

The network may indicate the configured list (i.e., the mapping) signaled to the UE in an area specific manner. That is, the second base station (gNB2) may indicate that the signaled list is for use by the UE in the registration area (RA) or one or more of the tracking areas (e.g., TA1 and/or TA2). The list (i.e., the mapping) may be signaled to the UE in a broadcast or in a dedicated manner. In an example, the second base station (gNB2) may send a RRC Release message including information corresponding to the list to the UE.

The information corresponding to the list may be included in one or more Information Elements (Ies) of the RRC Release message. The RRC Release message may further include additional information such as the indication of the default index. Other information included in the RRC Release message may include additional lists of frequency values or frequency priorities for cells or network slices of the network or served by other (neighboring) base stations.

At step 4, in the network, a message for a service may be received. For example, the core network function (e.g., the AMF) may receive a message for a service provided by the network (e.g., the second service (URLLC)). The network decides to page the UE to which the message is to be provided on the cell (e.g., the second cell (cell 2)). For example, the AMF may decide to page the UE for URLLC MT data (i.e., for data relating to URLLC which is to be provided to and thus terminating at the UE).

In response to deciding at step 4, the network sends paging message towards the UE at step 5. For example, the AMF sends the paging message to the second base station (gNB2) serving the second cell (cell 2) on which the UE is (or was lastly) camping. That is, the AMF may send a paging message to the second base station (gNB2) along with slice information indicating a specific slice (i.e., information indicating the second slice with the second service (URLLC)) of the paging message. The paging message may also be sent along with cell information indicating a specific cell (i.e., information indicating the first cell) of the paging message.

The network and more specifically, the second base station (gNB2) then may decide to perform slice/cell-specific redirection at step 6 (i.e., set or adjust frequency priorities) in response to receiving the paging message. As the paging message is determined by the second base station (gNB2) as being for the specific slice (e.g., the second slice) or the specific cell (e.g., the first cell) not supported by the second base station (gNB2), the second base station (gNB2) needs to redirect the paging message to the specific slice or the specific cell to which the paging message corresponds. That is, the second base station (gNB2) determines that the paging message does not correspond to a slice or cell which the second base station (gNB2) provides or serves.

The second base station (gNB2) may also determine that the paging message is for a slice or a cell that is supported by at least one (neighboring) base station of the network such as the first base station (gNB1).

At step 7, the network sends the paging message with an indication that the paging message corresponds to the specific network slice or the specific cell to the UE. For example, the second base station (gNB2) sends the paging message which includes an index indicating the paging message to correspond to the specific network slice or the specific cell.

For example, the paging message includes an index indicating that the paging message corresponds to the second slice that provides the second service (URLLC), i.e., the service for which data is to be provided to the UE, or the first cell (cell 1) which is the cell for which the second slice and the second service (URLLC) is configured. The paging message with the index indicates a frequency value or frequency priority for the specific slice or the specific cell.

In response to receiving the paging message with the index, the UE uses the index to obtain a frequency value or frequency priority from the list (i.e., the mapping) received at step 3. The frequency value or frequency priority obtained from the list using the index is used and set by the UE at step 8. For example, the UE may use the index into the list to re-calculate the frequency value or frequency priority for the specific network slice or the specific cell, to which the paging message corresponds.

At step 9, the UE may perform a reselection with the frequency value or the frequency priority obtained at step 8 and selects the specific network slice or the specific cell. For example, the UE may select the second slice with the second service (URLLC) or the first cell (cell 1) with the second slice using the frequency value or the frequency priority obtained at step 8. The UE may refrain from setting up an RRC connection and sending a service request for the service (URLLC) for which the network received the message at step 4 and for which the UE is paged on the second cell (cell 2).

In response to the selection of the specific network slice or the specific cell, the UE may perform RRC connection setup on the specific network slice or the specific cell at step 10 and send a service request for the service (i.e., the second service (URLLC)) to the network (e.g., the AMF) on the specific network slice (i.e., the second slice) or the specific cell (i.e., the first cell (cell 1)) at step 11.

According to the exemplary message sequence diagram shown in FIG. 10, the UE is not required to either go to RRC connected mode or initiate RRC connection setup to be guided to the network slice or cell for which the network paged the UE to send data for a service (e.g., URLLC). The processing load on network nodes such as the RAN node and delay in service access of the UE can be avoided. As a result, a method for enhanced paging behavior with non-homogenous slice support in a tracking area or in a registration area can be provided.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE and 5G NR, similar principles can be applied in relation to other networks and communication systems where enforcing fast connection re-establishment is required. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes exemplary embodiments, there are several variations and modifications which may be made to the disclosed solution without departing from the scope of the subject disclosure.

In general, the various exemplary embodiments may be implemented in hardware or special purpose circuits, software, logic or any combination thereof. Some aspects of the subject disclosure may be implemented in hardware, while other aspects may be implemented in firmware or software which may be executed by a controller, microprocessor or other computing device, although the subject disclosure is not limited thereto. While various aspects of the subject disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of the subject disclosure. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the subject disclosure as defined in the appended claims. Indeed, there is a further embodiment comprising a combination of one or more embodiments with any of the other embodiments previously discussed.

1-33. (canceled)

34. A method of paging of a user device, comprising:
receiving, by the user device, a paging message from a network node, the paging message comprising an index which indicates the paging message to correspond to a network slice or a cell;
receiving, by the user device, data from the network slice or the cell.

35. The method according to claim 34, further comprising:
obtaining, by the user device, a frequency or frequency priority based on the index, and
performing, by the user device, re-selection to the network slice or the cell using the frequency or frequency priority.

36. The method according to claim 34, further comprising:
receiving, by the user device, a configuration from the network node, the configuration comprising a mapping between a plurality of frequencies or frequency priorities and a plurality of indexes.

37. The method according to claim 34, further comprising:
setting up, by the user device, a connection in the network slice or to the cell; and/or
sending, by the user device, a service request on the network slice or the cell.

38. The method according to claim 34, wherein the user device is camping on a first cell of a network and the cell is a second cell of the network different to the first cell.

39. A user device, comprising:
at least one processor; and
at least one memory including computer program code, wherein the computer program code causes the user device, when executed with the at least one processor, to at least:
receive a paging message from a network node, the paging message comprising an index which indicates the paging message to correspond to a network slice or a cell;
receive data from the network slice or the cell.

40. The user device according to claim 39, wherein the computer program code further causes the user device, when executed with the at least one processor, to:
obtain a frequency or frequency priority based on the index, and
perform re-selection to the network slice or the cell using the frequency or frequency priority.

41. The user device according to claim 39, wherein the computer program code further causes the user device, when executed with the at least one processor, to:
receive a configuration from the network node, the configuration comprising a mapping between a plurality of frequencies or frequency priorities and a plurality of indexes.

42. The user device according to claim 39, wherein the computer program code further causes the user device, when executed with the at least one processor, to:
receive a configuration from the network node, the configuration comprising a mapping between a plurality of frequencies or frequency priorities and a plurality of indexes and wherein the mapping is obtained from system information or dedicate signaling.

43. The user device according to claim 39, wherein the computer program code further causes the user device, when executed with the at least one processor, to:
receive a configuration from the network node, the configuration comprising a mapping between a plurality of frequencies or frequency priorities and a plurality of indexes, and
obtain a frequency or frequency priority corresponding to the index from the mapping.

44. The user device according to claim 39, wherein the computer program code further causes the user device, when executed with the at least one processor, to:
perform re-selection to the network slice or the cell using the obtained frequency or frequency priority.

45. The user device according to claim 39, wherein the computer program code further causes the user device, when executed with the at least one processor, to:
set up a connection in the network slice or to the cell; and/or
send a service request on the network slice or the cell.

46. The user device according to claim 39, wherein the user device is camping on a first cell and the cell is a second cell different to the first cell.

47. A network device, comprising:
at least one processor; and
at least one memory including computer program code, wherein the computer program code causes the network device, when executed with the at least one processor, to:
send a paging message to a user device, the paging message comprising an index which indicates the paging message to correspond to a network slice or a cell;
send, to the user device, data from the network slice or the cell.

48. The network device according to claim 47, wherein the computer program code further causes the network device, when executed with the at least one processor, to:
send a configuration to the user device, the configuration comprising a mapping between a plurality of frequencies or frequency priorities and a plurality of indexes.

49. The network device according to claim 47, wherein the computer program code further causes the network device, when executed with the at least one processor, to:
send a configuration to the user device, the configuration comprising a mapping between a plurality of frequencies or frequency priorities and a plurality of indexes, and provide the mapping by system information or dedicate signaling.

50. The network device according to claim 47, wherein the computer program code further causes the network device, when executed with the at least one processor, to:
decide whether to set frequencies priorities based on a determination that the paging message corresponds to the network slice or the cell not supported by the network node.

51. The network device according to claim 47, wherein the computer program code further causes the network device, when executed with the at least one processor, to:
set up a connection in the network slice or the cell with the user device;
receive a service request on the network slice or the cell.

52. The network device according to claim 47, wherein the user device is camping on a first cell and the cell is a second cell different to the first cell.
